(19) United States
(12) Patent Application Publication
(10) Pub. No.: US 2023/0118224 A1
(43) Pub. Date: Apr. 20, 2023

(54) SEPARATOR, ELECTROCHEMICAL APPARATUS, AND ELECTRONIC APPARATUS

(71) Applicant: Ningde Amperex Technology Limited, Ningde City (CN)

(72) Inventor: Chuantao Song, Ningde City (CN)

(73) Assignee: Ningde Amperex Technology Limited, Ningde City (CN)

(21) Appl. No.: 17/967,327

(22) Filed: Oct. 17, 2022

(30) Foreign Application Priority Data
Oct. 19, 2021 (CN) 202111217231.4

(51) Int. Cl. H01M 50/457; H01M 50/489; H01M 50/451; H01M 50/434; H01M 50/417; H01M 50/46

(52) U.S. Cl. CPC H01M 50/457; H01M 50/489; H01M 50/451; H01M 50/434; H01M 50/417; H01M 50/46

(57) ABSTRACT

A separator includes a substrate layer and a first layer disposed on a surface of the substrate layer, where a differential scanning calorimetry curve of the first layer has a first endothermic peak and a second endothermic peak, where a temperature corresponding to the first endothermic peak is Q₁° C., a temperature corresponding to the second endothermic peak is Q₂° C., 100≤Q₁≤130, and 140≤Q₂≤200.

### CROSS-REFERENCE TO RELATED APPLICATION

The present application claims benefit of Chinese Patent Application Serial No. 202111217231.4, filed on Oct. 19, 2021, the content of which is incorporated by reference in its entirety.

### TECHNICAL FIELD

This application relates to the field of energy storage technologies, and in particular, to a separator, an electrochemical apparatus, and an electronic apparatus.

### BACKGROUND

In a lithium-ion battery as voltage and energy density of an electrochemical apparatus gradually increase, a chemical system gradually generates more heat, and a risk of internal short circuit due to overheating increases. As a result, safety of the electrochemical apparatus gradually declines. Due to inherent properties of a separator substrate of the lithium-ion battery at a high temperature, a separator tends to shrink under an unreasonable temperature condition, such as overcharge, and a location of shrinkage is a dangerous zone where short circuit is likely to occur. If short circuit occurs inside the electrochemical apparatus, the electrochemical apparatus is susceptible to thermal runaway and fire.

### SUMMARY

In view of the problems existing in the prior art, this application provides a separator, an electrochemical apparatus, and an electronic apparatus. Use of the separator provided in this application can improve safety performance of the electrochemical apparatus while maintaining high electrical performance.

According to a first aspect, this application provides a separator. The separator includes a substrate layer and a first layer disposed on a surface of the substrate layer, where a differential scanning calorimetry analysis curve of the first layer has a first endothermic peak and a second endothermic peak, where a temperature corresponding to the first endothermic peak is Q₁° C., a temperature corresponding to the second endothermic peak is Q₂C, 100≤Q₁≤130, and 140≤Q₂≤200.

The first layer of the separator in this application maintains a relatively high interfacial adhesion strength between the first layer and the substrate layer at a low temperature such as normal temperature. When the temperature increases unreasonably and reaches a designed temperature, the adhesion strength between the first layer and the substrate layer decreases. In addition, for an electrochemical apparatus, there are generally more side reactions and more gas under a high temperature, resulting in swelling of the electrochemical apparatus. Under the action of an interface peeling force, the first layer is peeled off from the substrate layer, thereby reducing a risk of short circuit caused by shrinkage of the separator under a high temperature and improving high-temperature resistance performance and overcharge protection performance.

According to some embodiments of this application, Q₁ may be 102, 105, 108, 110, 112, 115, 118, 120, 122, 125, 128, or any value between any two of these values. In some embodiments of this application, 110≤Q₁ 120. According to some embodiments of this application, Q₂ may be 145, 150, 155, 160, 165, 170, 175, 180, 185, 190, 195, or any value between any two of these values. In some embodiments of this application, 140≤Q₂≤l70. In some embodiments of this application, 110≤Q₁≤120, and 140≤Q₂≤170.

According to some embodiments of this application, Q₂−Q₁≥20. In some embodiments of this application, Q₂-Q₁ is 21, 22, 23, 25, 30, 35, 45, 55, 65, 75, 85, 95, or any value between any two of these values. According to some embodiments of this application, 20≤Q₂-Q₁≤60.

According to some embodiments of this application, F₂₅ represents an adhesion strength between the first layer and the substrate layer measured at 25° C., F_{Q1-10} represents an adhesion strength between the first layer and the substrate layer measured at Q₁-10° C., and −0.05 N/m F_{Q1-10}-F₂₅ 0.05 N/m; and Fₜ₁ represents an adhesion strength between the first layer and the substrate layer measured at t₁° C., Fₜ₂ represents an adhesion strength between the first layer and the substrate layer measured at t₂° C., t₁>t₂>Q₁−10, and Fₜ₁<Fₜ₂. When the temperature is below Q₁−10° C., the adhesion strength between the first layer and the substrate layer remains basically unchanged. When the temperature is above Q₁-10° C., the adhesion strength between the first layer and the substrate layer decreases with an increase in the temperature. When the adhesion strength between the first layer and the substrate layer decreases to ≤2 N/m, the first layer and the substrate layer are separated from each other.

According to some embodiments of this application, F represents an adhesion strength between the first layer and the substrate layer measured at a temperature t° C., 0 N/m<F≤2 N/m, and Q₁−10≤t≤Q₂. According to some embodiments of this application, when t is Q₁-10, Q₁−5, Q₁, Q₂, or any value between any two of these values, F≤2 N/m, for example, is 1.8 N/m, 1.6 N/m, 1.4 N/m, 1.2 N/m, 1.0 N/m, 0.8 N/m, 0.6 N/m, 0.4 N/m, 0.2 N/m, 0 N/m, or any value between any two of these values.

According to some embodiments of this application, the first layer includes a second layer and a third layer that are stacked, the second layer is located between the substrate layer and the third layer, the second layer includes first inorganic particles and a first binder, and the third layer includes second inorganic particles and a second binder.

According to some embodiments of this application, the first layer includes a first adhesive layer, a fourth layer, and a second adhesive layer that are stacked in sequence, the first adhesive layer is located between the substrate layer and the fourth layer, the first adhesive layer includes a first binder, the second adhesive layer includes a second binder, and the fourth layer includes second inorganic particles.

According to some embodiments of this application, the first inorganic particles and the second inorganic particles are each independently selected from one or more of aluminum oxide, magnesium oxide, silicon dioxide, titanium dioxide, zirconium dioxide, aluminum hydroxide, magnesium hydroxide, zinc oxide, barium sulfate, or boehmite. According to some embodiments of this application, the first inorganic particles or the second inorganic particles may have various shapes, such as sphere, ellipsoid, long plate, cube, and terrace. Generally, a long plate or sphere shape is preferred. According to some embodiments of this application, the first inorganic particles or the second inorganic particles each have a diameter or height less than 5 μm.

According to some embodiments of this application, the first binder includes one or more of ethylene-propylene random polymer, ethylene propylene rubber, or block copolymer polypropylene. A melting point of the first binder is low, so that the second layer containing the first binder has a characteristic of low adhesion strength under a high temperature. At a specific temperature (for example, about 100° C.), an interfacial adhesion strength between the second layer containing the first binder and the substrate layer starts to decrease. According to some embodiments of this application, the second binder includes one or more of polypropylene, ethylene-butene copolymer; ethylene-propylene copolymer, propylene-butene copolymer, or ethylene-propylene-butene copolymer. A melting point of the second binder is high and can withstand a higher temperature, so that the third layer containing the second binder has a characteristic of high temperature resistance.

According to some embodiments of this application, in a differential scanning calorimetry curve of the first binder, a temperature corresponding to an endothermic peak is P₁° C., and in a differential scanning calorimetry curve of the second binder, a temperature corresponding to an endothermic peak is P₂° C., where 100≤P₁≤130, and 140≤P₂≤200. According to some embodiments of this application, P₁ is 102, 105, 108, 110, 112, 115, 118, 120, 122, 125, 128, or any value between any two of these values. According to some embodiments of this application. P₂ is 145, 150, 155, 160, 165, 170, 175, 180, 185, 190, 195, or any value between any two of these values. In some embodiments of this application, 110≤P₁≤120, and 140≤P≤170.

According to some embodiments of this application, P₂−P₁≥20. In some embodiments of this application, P₂-P₁ is 25, 35, 45, 55, 65, 75, 85, 95, or any value between any two of these values. According to some embodiments of this application, 20≤P₂−P₁≤60.

According to some embodiments of this application, the second layer includes first inorganic particles and a first binder, and based on a weight of the second layer, a weight percentage of the first inorganic particles is greater than or equal to 95%, and a weight percentage of the first binder is less than or equal to 5%. If the amount of the first binder is increased, the interfacial adhesion strength between the second layer and the substrate layer can be improved, but excessive binders may block pores of the substrate layer, resulting in decreased air permeability. Therefore, the weight percentage of the binder is usually controlled within 5a.

According to some embodiments of this application, the second layer further includes a dispersant, and based on a weight of the second layer, a weight percentage of the dispersant is less than or equal to 1%. In some embodiments, the dispersant contains sodium carboxymethyl cellulose (CMC). In some embodiments, the dispersant is sodium carboxymethyl cellulose (CMC).

According to some embodiments of this application, the second layer is 1 pin to 5 μm thick. In some embodiments, the second layer is 1 μm to 2 μm thick.

According to some embodiments of this application, the third layer includes second inorganic particles and a second binder, and based on a weight of the third layer, a weight percentage of the second inorganic particles is greater than or equal to 95%, and a weight percentage of the second binder is less than or equal to 5%. If the amount of the second binder is increased, the interfacial adhesion strength between the third layer and the second layer can be improved, but excessive binders may block pores of the substrate layer, resulting in decreased air permeability. Therefore, the weight percentage of the binder is usually controlled within 5%.

According to some embodiments of this application, the third layer further includes a dispersant, and based on a weight of the third laver, a weight percentage of the dispersant is less than or equal to 1%. In some embodiments, the dispersant contains sodium carboxymethyl cellulose (CMC). In some embodiments, the dispersant is sodium carboxymethyl cellulose (CMC).

According to some embodiments of this application, the third laver is 1 μm to 5 μm thick. In some embodiments, the third layer is 1 μm to 2 μm thick.

According to some embodiments of this application, the second layer and the third layer each may be implemented as a coating layer through coating. In some embodiments, the second layer and the third layer can be implemented by performing double-layer coating once or performing single-layer coating twice.

The substrate layer of the separator that can be used in the embodiments of this application is not limited to a specific material or shape, and any technology disclosed in the prior art may be used for the substrate layer. In some embodiments, the substrate layer of the separator includes a polymer or an inorganic substance formed by a material stable to the electrolyte of this application.

According to some embodiments of this application, the substrate layer of the separator is a non-woven fabric, film, or composite film of a porous structure. The substrate layer is made of at least one of polyethylene, polypropylene, polyethylene terephthalate, or polyimide. Specifically, a polypropylene porous film, a polyethylene porous film, polypropylene non-woven fabric, polyethylene non-woven fabric, or a polypropylene-polyethylene-polypropylene porous composite film may be selected.

According to a second aspect, this application provides an electrochemical apparatus, including an electrode assembly, where the electrode assembly includes a first electrode plate, a second electrode plate, and the separator according to the first aspect, where the separator is stacked between the first electrode plate and the second electrode plate, and the first layer is in contact with the first electrode plate.

According to some embodiments of this application, the electrode assembly of the electrochemical apparatus includes a first electrode plate, a second electrode plate, and a separator located between the first electrode plate and the second electrode plate, where the separator includes a substrate layer and a first layer disposed on a surface of the substrate layer. Under a condition that an internal temperature of the electrochemical apparatus is T>P₁, more gas is produced, and the accumulated gas causes the electrochemical apparatus to deform, leaving an interface between the first electrode plate and the separator subjected to a peeling force F. When the peeling force F is greater than an interfacial adhesion strength between the first electrode plate and the separator, at least part of the first layer is peeled off from the surface of the separator substrate layer and transferred to a surface of the first electrode plate, and the interface between the first electrode plate and the separator is broken. Even if the separator partially shrinks, the first layer can act as an insulating layer, thereby reducing a risk of short circuit caused by contact. In some specific embodiments of this application, the separator includes a substrate layer, a second layer, and a third layer that are sequentially stacked in a thickness direction of the separator, and the third layer is in contact with the first electrode plate, where the second layer includes first inorganic particles and a first binder, and the third layer includes second inorganic particles and a second binder. In this case, under a condition that an internal temperature of the electrochemical apparatus is T>P₂, an interfacial adhesion strength F₁ between the third layer and the first electrode plate can be maintained at a high level, and therefore the third layer is tightly adhered to the first electrode plate. However, under a condition that an internal temperature of the electrochemical apparatus is T>P₁, an interfacial adhesion strength F₂ between the second layer and the third layer or the substrate layer starts to decrease, reaching or approaching 0 N/m. As a result, the second layer is partially adhered to the third layer or the substrate layer, an interface between the second layer and the third layer or the substrate layer is broken, and at least part of the third layer is transferred to a surface of the first electrode plate.

According to some embodiments of this application, the first layer includes second inorganic particles, the first electrode plate includes a first current collector and a first active material layer that are stacked, the first electrode plate has a first portion, and a surface of the first active material layer of the first portion is covered with the second inorganic particles. S₁ represents an area, measured at t₃° C. of the surface of the first active material layer of the first portion covered by the second inorganic particles, S₂ represents an area, measured at t₄° C., of the surface of the first active material layer of the first portion covered by the second inorganic particles, S₂>S₁, t₃≤30, and Q₁≤t₄≤Q₂.

According to some embodiments of this application, the separator further includes a fifth layer disposed on a surface of the substrate layer, the first layer and the fifth layer are respectively provided on two opposite surfaces of the substrate layer, the fifth layer is in contact with the second electrode plate, and the fifth layer includes the first binder and/or the second binder. In some embodiments of this application, the fifth laver includes a first binder, and both sides of the substrate layer can be separated under a high temperature. Therefore, safety is better. In some other embodiments of this application, the fifth layer includes a second binder, and the first layer is separated more easily under a high temperature. Therefore, safety can also be improved. According to some embodiments of this application, the fifth layer further includes first inorganic particles and/or second inorganic particles.

According to some specific embodiments of this application, the first electrode plate is a positive electrode plate, the second electrode plate is a negative electrode plate, and the separator may be disposed in different manners.

In some embodiments, the third layer, the second layer, the substrate layer, and the fifth layer are sequentially stacked between the positive electrode plate and the negative electrode plate. The third layer includes a second binder and second inorganic particles, and has a characteristic of high temperature resistance. The second layer includes a first binder and first inorganic particles, and has a characteristic of low adhesion strength under a high temperature. The fifth layer includes the second binder and the second inorganic particles, and has a characteristic of high temperature resistance. Under a high temperature, an interface between the third layer and the second layer is broken, and peeling occurs.

In some embodiments, the third layer, the second layer, the substrate layer, and the fifth layer are sequentially stacked between the positive electrode plate and the negative electrode plate. The third layer includes a second binder and second inorganic particles, and has a characteristic of high temperature resistance. The second layer includes a first binder and first inorganic particles, and has a characteristic of low adhesion strength under a high temperature. The fifth layer includes the second binder, and has a characteristic of high temperature resistance. Under a high temperature, an interface between the third layer and the second layer is broken, and peeling occurs.

In some embodiments, the third layer, the second layer, the substrate layer, and the fifth layer are sequentially stacked between the positive electrode plate and the negative electrode plate. The third layer includes a second binder and second inorganic particles, and has a characteristic of high temperature resistance. The second layer includes a first binder and first inorganic particles, and has a characteristic of low adhesion strength under a high temperature. The fifth layer includes a first binder, and has a characteristic of low adhesion strength under a high temperature. Under a high temperature, an interface between the third layer and the second layer is broken, and peeling occurs.

According to a third aspect, this application provides an electronic apparatus, including the electrochemical apparatus according to the second aspect.

In this application, a separator including a specified structure is selected, so that an electrochemical apparatus using such separator can keep an inorganic particle coating layer covering a surface of an electrode plate under an unreasonable temperature to prevent short circuit caused by contact, thereby improving safety performance of the electrochemical apparatus without compromising electrical performance. The separator provided in this application is a new safety technology that improves safety of the electrochemical apparatus based on a coating layer design of the separator, thereby avoiding using an electrolyte adjustment solution to improve thermal stability of the electrochemical apparatus at the cost of greater electrical performance losses.

### BRIEF DESCRIPTION OF DRAWINGS

FIG. 1 is a schematic structural diagram of a separator according to an embodiment of this application.

FIG. 2 is a schematic structural diagram of a separator according to another embodiment of this application.

FIG. 3 is a schematic structural diagram of a separator according to another embodiment of this application.

FIG. 4 is a schematic structural diagram of the separator in FIG. 1 after peeling off under a high temperature according to this application.

FIG. 5 is a schematic structural diagram of the separator in FIG. 2 after peeling off under a high temperature according to this application.

FIG. 6 is a schematic structural diagram of the separator in FIG. 3 after peeling off under a high temperature according to this application.

FIG. 7 shows a shape of a first inorganic particle or a second inorganic particle according to this application.

FIG. 8 shows a high temperature adhesion strength curve of a coating layer of a separator according to Example 1 of this application.

FIG. 9 shows a differential scanning calorimetry curve of a coating layer of a separator according to Example 1 of this application.

FIG. 10 is a schematic structural diagram of a wound lithium-ion battery according to an embodiment of this application.

### REFERENCE SIGNS

1. positive electrode plate, 2. third layer, 3. second layer, 4. substrate layer, 5. fifth layer, 6. negative electrode plate, 7. separator, 8. separator, 9. separator, 10. positive-electrode tab, 11. negative-electrode tab, 12. sphere, 13. ellipsoid, 14. long plate, 15. cube, and 16. terrace.

### DETAILED DESCRIPTION

To make the objectives, technical solutions, and advantages of this application clearer, the technical solutions in this application are described clearly and completely below with reference to the embodiments. Apparently, the described embodiments are some but not all of the embodiments of this application. The embodiments described herein are illustrative in nature and used to provide a basic understanding of this application. The embodiments of this application shall not be construed as a limitation on this application.

For brevity, this specification specifically discloses only some numerical ranges. However, any lower limit may be combined with any upper limit to form a range not explicitly recorded, and any lower limit may be combined with another lower limit to form a range not explicitly recorded, and likewise, any upper limit may be combined with any other upper limit to form a range not explicitly recorded. In addition, each point or individual value may act as its own lower limit or upper limit to be combined with any other point or individual value or combined with any other lower limit or upper limit to form a range not expressly recorded.

In the descriptions of this specification, “more than” or “less than” is inclusive of the present number unless otherwise specified.

Unless otherwise specified, terms used in this application have common meanings generally understood by persons skilled in the art. Unless otherwise specified, numerical values of parameters mentioned in this application may be measured by using various measurement methods commonly used in the art (for example, testing may be performed by using a method provided in the embodiments of this application).

A list of items connected by the terms “at least one of” “at least one piece of”, “at least one kind of”, or the like may mean any combination of the listed items. For example, if items A and B are listed, the phrase “at least one of A and B” means only A; only B; or A and B. In another example, if items A, B, and C are listed, the phrase “at least one of A, B, and C” means only A, only B, only C, A and B (excluding C), A and C (excluding B), B and C (excluding A), or all of A. B, and C. The item A may contain a single constituent or a plurality of constituents. The item B may contain a single constituent or a plurality of constituents. The item C may contain a single constituent or a plurality of constituents.

I. Separator

According to a first aspect, this application provides a separator. The separator includes a substrate layer and a first layer disposed on a surface of the substrate layer, where a differential scanning calorimetry analysis curve of the first layer has a first endothermic peak and a second endothermic peak, where a temperature corresponding to the first endothelin peak is Q₁° C., a temperature corresponding to the second endothermic peak is Q₂° C., 100≤Q₁≤130, and 140≤Q₂≤200.

The first layer of the separator in this application maintains a relatively high interfacial adhesion strength between the first layer and the substrate layer at a low temperature such as normal temperature. When the temperature rises and reaches a designed temperature, the adhesion strength between the first layer and the substrate layer decreases. In addition, for an electrochemical apparatus, there are generally more side reactions and more gas under a high temperature, resulting in swelling of the electrochemical apparatus. Under the action of an interface peeling force, the first layer is peeled off from the substrate layer, thereby reducing a risk of short circuit caused by shrinkage of the separator under a high temperature.

According to some embodiments of this application, Q₁ may be 102, 105, 108, 110, 112, 115, 118, 120, 122, 125, 128, or any value between any two of these values. In some embodiments of this application, 110≤Q₁≤120. According to some embodiments of this application, Q₂ may be 145, 150, 155, 160, 165, 170, 175, 180, 185, 190, 195, or any value between any two of these values. In some embodiments of this application, 140≤Q₂170. In some embodiments of this application, 110≤Q₁≤120, and 140≤Q₂≤170.

According to some embodiments of this application, Q₂-Q₁≤20. In some embodiments of this application. Q₂-Q₁ is 21, 22, 23, 25, 30, 35, 45, 55, 65, 75, 85, 95, or any value between any two of these values. According to some embodiments of this application, 20≤Q₂-Q₁≤60.

According to some embodiments of this application, F₂₅ represents an adhesion strength between the first layer and the substrate layer measured at 25° C.; F_{Q1-10} represents an adhesion strength between the first layer and the substrate layer measured at Q₁₋₁₀° C., and −0.05 N/m≤F_{Q1-10}-F₂₅≤0.05 N/m; Fₜ₁ represents an adhesion strength between the first layer and the substrate layer measured at t₁° C.; and Fₜ₂ represents an adhesion strength between the first layer and the substrate layer measured at t₂° C., t₁>t₂>Q₁-10, and Fₜ₁<Fₜ₂. When the temperature is below Q₁-10° C., the adhesion strength between the first layer and the substrate layer remains basically unchanged. When the temperature is above Q₁−10° C., the adhesion strength between the first layer and the substrate layer decreases with an increase in the temperature. When the adhesion strength between the first layer and the substrate layer decreases to ≤2 N/m, the first layer and the substrate layer are separated from each other.

According to some embodiments of this application. F represents an adhesion strength between the first layer and the substrate layer measured at a temperature t° C., 0 N/m<F≤2 N/m, and Q₁−10≤Q₂. According to some embodiments of this application, when t is Q₁-10, Q₁-5, Q₁, Q₂, or any value between any two of these values, F₂≤N/m, for example, is 1.8 N/m, 1.6 N/m, 1.4 Nm, 1.2 N/m, 1.0 N/m, 0.8 N/m, 0.6 N/m, 0.4 N/m, 0.2 N/m, 0 N/m, or any value between any two of these values.

According to some embodiments of this application, the first layer includes a second layer and a third layer that are stacked, the second layer is located between the substrate layer and the third layer, the second layer includes first inorganic particles and a first binder, and the third layer includes second inorganic particles and a second binder.

According to some embodiments of this application, the first layer includes a first adhesive layer, a fourth layer, and a second adhesive layer that are stacked in sequence, the first adhesive layer is located between the substrate layer and the fourth layer, the first adhesive layer includes a first binder, the second adhesive layer includes a second binder, and the fourth layer includes second inorganic particles.

According to some embodiments of this application, the first inorganic particles and the second inorganic particles are each independently selected from one or more of aluminium oxide, magnesium oxide, silicon dioxide, titanium dioxide, zirconium dioxide, aluminum hydroxide, magnesium hydroxide, zinc oxide, barium sulfate, or boehmite. According to some embodiments of this application, the first inorganic particles or the second inorganic particles may have various shapes, such as sphere, ellipsoid, long plate, cube, and terrace. Generally, a long plate or sphere shape is preferred. According to some embodiments of this application, the first inorganic particles or the second inorganic particles each have a diameter or height less than 5 μm.

According to some embodiments of this application, the first binder includes one or more of ethylene-propylene random polymer, ethylene propylene rubber, or block copolymer polypropylene. A melting point of the first binder is low, so that the second layer containing the first binder has a characteristic of low adhesion strength under a high temperature. At a specific temperature (for example, about 100° C.), an interfacial adhesion strength between the second layer containing the first binder and the substrate layer starts to decrease. According to some embodiments of this application, the second binder includes one or more of polypropylene, ethylene-butene copolymer, ethylene-propylene copolymer, propylene-butene copolymer, or ethylene-propylene-butene copolymer. A melting point of the second binder is high and can withstand a higher temperature, so that the third layer containing the second binder has a characteristic of high temperature resistance.

According to some embodiments of this application, in a differential scanning calorimetry curve of the first binder, a temperature corresponding to an endothermic peak is P₁° C., and in a differential scanning calorimetry curve of the second binder, a temperature corresponding to an endothermic peak is P₂° C., where 100≤P₁≤130, and 140≤P₂200. According to some embodiments of this application, P₁ is 102, 105, 108, 110, 112, 115, 118, 120, 122, 125, 128, or any value between any two of these values. According to some embodiments of this application, P₂ is 145, 150, 155, 160, 165, 170, 175, 180, 185, 190, 195, or any value between any two of these values. In some embodiments of this application, 110≤P₁≤120, and 140≤P₂≤170.

According to some embodiments of this application, P₂-P₁≥20. In some embodiments of this application, P₂-P₁ is 25, 35, 45, 55, 65, 75, 85, 95, or any value between any two of these values. According to some embodiments of this application, 20≤P₂-P₁≤60.

According to some embodiments of this application, the second layer includes first inorganic particles and a first binder, and based on a weight of the second layer, a weight percentage of the first inorganic particles is greater than or equal to 95%, and a weight percentage of the first binder is less than or equal to 5%. If the amount of the first binder is increased, the interfacial adhesion strength between the second layer and the substrate layer can be improved, but excessive binders may block pores of the substrate layer, resulting in decreased air permeability. Therefore, the weight percentage of the binder is usually controlled within 5%.

According to some embodiments of this application, the second layer further includes a dispersant, and based on a weight of the second layer, a weight percentage of the dispersant is less than or equal to 1%. In some embodiments, the dispersant contains sodium carboxymethyl cellulose (CMC). In some embodiments, the dispersant is sodium carboxymethyl cellulose (CMC).

According to some embodiments of this application, the second layer is 1 m to 5 μm thick. In some embodiments, the second layer is 1 μm to 2 μm thick.

According to some embodiments of this application, the third layer includes second inorganic particles and a second binder, and based on a weight of the third layer, a weight percentage of the second inorganic particles is greater than or equal to 95%, and a weight percentage of the second binder is less than or equal to 5%. If the amount of the second binder is increased, the interfacial adhesion strength between the third layer and the second layer can be improved, but excessive binders may block pores of the substrate layer, resulting in decreased air permeability. Therefore, the weight percentage of the binder is usually controlled within 5%.

According to some embodiments of this application, the third layer further includes a dispersant, and based on a weight of the third layer, a weight percentage of the dispersant is less than or equal to 1%. In some embodiments, the dispersant contains sodium carboxymethyl cellulose (CMC). In some embodiments, the dispersant is sodium carboxymethyl cellulose (CMC).

According to some embodiments of this application, the third layer is 1 μm to 5 μm thick. In some embodiments, the third layer is 1 μm to 2 μm thick.

According to some embodiments of this application, the second layer and the third layer each may be implemented as a coating layer through coating. In some embodiments, the second layer and the third layer can be implemented by performing double-layer coating once or performing single-layer coating twice.

The substrate layer of the separator that can be used in the embodiments of this application is not limited to a specific material or shape, and ay technology disclosed in the prior art may be used for the substrate layer. In some embodiments, the substrate layer of the separator includes a polymer or an inorganic substance formed by a material stable to the electrolyte of this application.

According to some embodiments of this application, the substrate layer of the separator is a non-woven fabric, film, or composite film of a porous structure. The substrate layer is made of at least one of polyethylene, polypropylene, polyethylene terephthalate, or polyimide. Specifically, a polypropylene porous film, a polyethylene porous film, polypropylene non-woven fabric, polyethylene non-woven fabric, or a polypropylene-polyethylene-polypropylene porous composite film may be selected.

II. Electrochemical Apparatus

The electrochemical apparatus provided in this application includes an electrode assembly, where the electrode assembly includes a first electrode plate, a second electrode plate, and the separator according to the first aspect, where the separator is stacked between the first electrode plate and the second electrode plate, and the first layer is in contact with the first electrode plate.

According to some embodiments of this application, the electrochemical apparatus further includes a housing for accommodating the electrode assembly.

According to some embodiments of this application, the electrode assembly of the electrochemical apparatus includes a first electrode plate, a second electrode plate, and a separator located in between, where the separator includes a substrate layer and a first layer disposed on a surface of the substrate layer. Under a condition that an internal temperature of the electrochemical apparatus is T>P₁, more gas is produced, and the gas accumulated inside the electrochemical apparatus causes the electrochemical apparatus to deform, leaving an interface between the first electrode plate and the separator subjected to a peeling force F. When the peeling force F is greater than an interfacial adhesion strength between the first electrode plate and the separator, at least pail of the first layer is peeled off from the surface of the separator substrate layer and transferred to a surface of the first electrode plate, and the interface between the first electrode plate and the separator is broken. Even if the separator partially shrinks, the first layer can act as an insulating layer, thereby reducing a risk of short circuit caused by contact. In some specific embodiments of this application, the separator includes a substrate layer, a second layer, and a third layer that are sequentially stacked in a thickness direction of the separator, and the third layer is in contact with the first electrode plate, where the second layer includes first inorganic particles and a first binder, and the third layer includes second inorganic particles and a second binder. In this case, under a condition that an internal temperature of the electrochemical apparatus is T>P₂, an interfacial adhesion strength F₁ between the third layer and the first electrode plate does not significantly decrease, and therefore the third layer is tightly adhered to the first electrode plate. However, under a condition that an internal temperature of the electrochemical apparatus is T>P₁, an interfacial adhesion strength F₂ between the second layer and the third layer or the substrate layer starts to decrease, reaching or approaching 0 N/m. As a result, the second layer is partially adhered to the third layer or the substrate layer, an interface between the second layer and the third layer or the substrate layer is broken, and at least part of the third layer is transferred to a surface of the first electrode plate.

According to some embodiments of this application, the first layer includes second inorganic particles, the first electrode plate includes a first current collector and a first active material layer that are stacked, the first electrode plate has a first portion, and a surface of the first active material layer of the first portion is covered with the second inorganic particles. S₁ represents an area, measured at t₃° C., of the surface of the first active material layer of the first portion covered by the second inorganic particles, S₂ represents an area, measured at t₄° C., of the surface of the first active material layer of the first portion covered by the second inorganic particles, S₂>S₁, t₃≤30, and Q₁≤t₄≤Q₂.

According to some embodiments of this application, the separator further includes a fifth layer disposed on a surface of the substrate layer, the first layer and the fifth layer are respectively provided on two opposite surfaces of the substrate layer, the fifth layer is in contact with die second electrode plate, and the fifth layer includes the first binder and/or the second binder. In some embodiments of this application, the fifth laver includes a first binder, and both sides of the substrate layer can be separated under a high temperature. Therefore, safety is better. In some other embodiments of this application, the fifth layer includes a second binder, and the first layer is separated more easily under a high temperature. Therefore, safety can also be improved. According to some embodiments of this application, the fifth layer further includes first inorganic particles and/or second inorganic particles.

According to some specific embodiments of this application, the first electrode plate is a positive electrode plate, the second electrode plate is a negative electrode plate, and the separator may be disposed in different manners.

In some embodiments, as shown in FIG. 1, the third layer 2, die second layer 3, the substrate layer 4, and the fifth layer 5 are sequentially stacked between the positive electrode plate 1 and the negative electrode plate 6. The third layer 2 includes a second binder and second inorganic particles, and has a characteristic of high temperature resistance. The second layer 3 includes a first binder and first inorganic particles, and has a characteristic of low adhesion strength under a high temperature. The fifth layer 5 includes the second binder and die second inorganic particles, and has a characteristic of high temperature resistance. Under a high temperature, an interface between the third layer 2 and the second layer 3 is broken, and peeling occurs, as shown in FIG. 4.

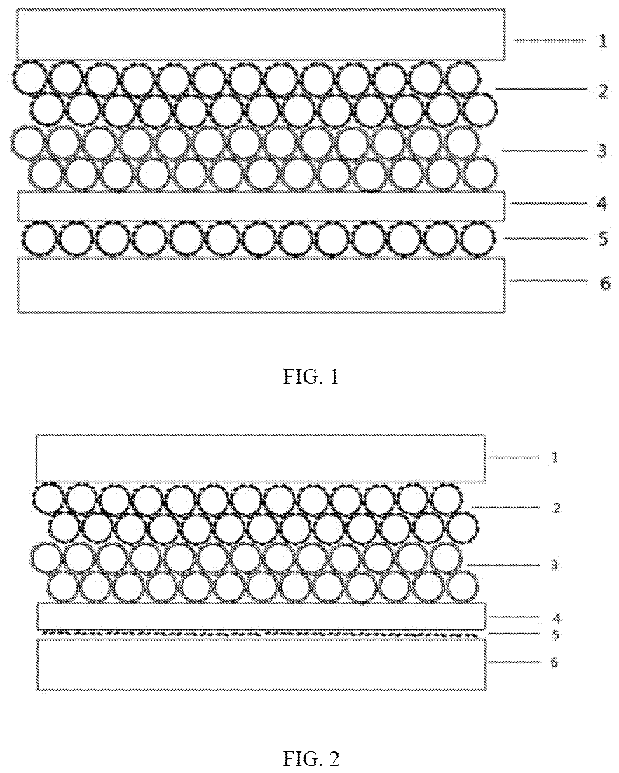

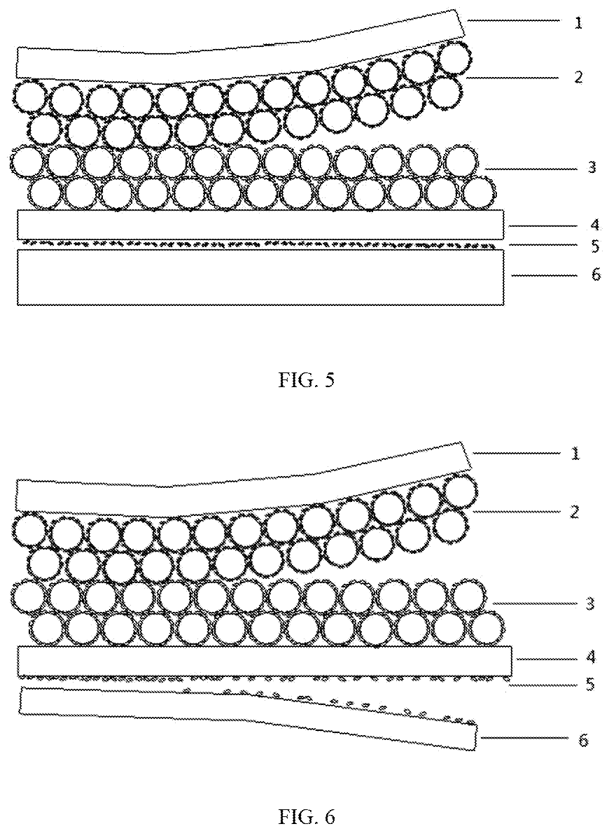

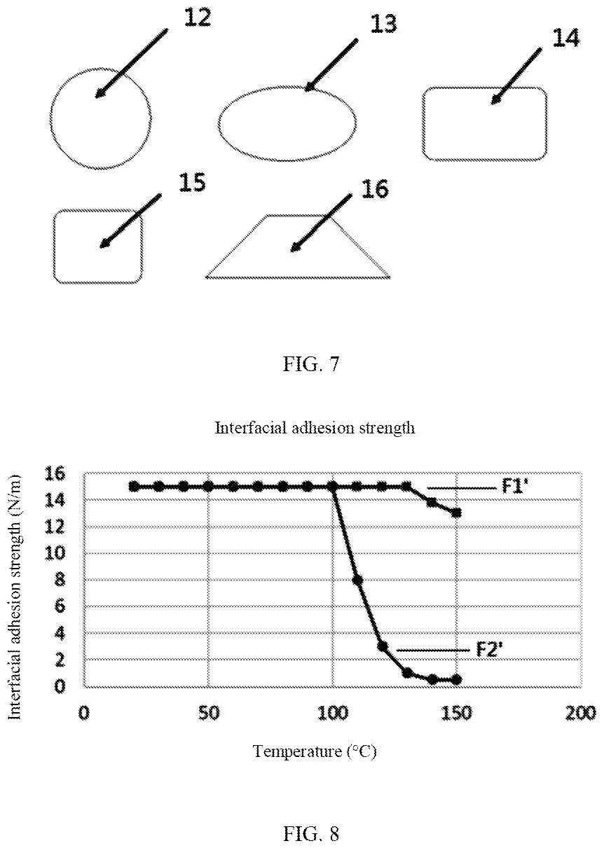

In some embodiments, as shown in FIG. 2, the third layer 2, the second layer 3 the substrate layer 4, and the fifth layer 5 are sequentially stacked between the positive electrode plate 1 and the negative electrode plate 6. The third layer 2 includes a second binder and second inorganic particles, and has a characteristic of high temperature resistance. The second layer 3 includes a first binder and first inorganic particles, and has a characteristic of low adhesion strength under a high temperature. The fifth layer 5 includes the second binder, and has a characteristic of high temperature resistance. After peeling under a high temperature, an interface between the third layer 2 and the second layer 3 is broken, and peeling occurs, as shown in FIG. 5.

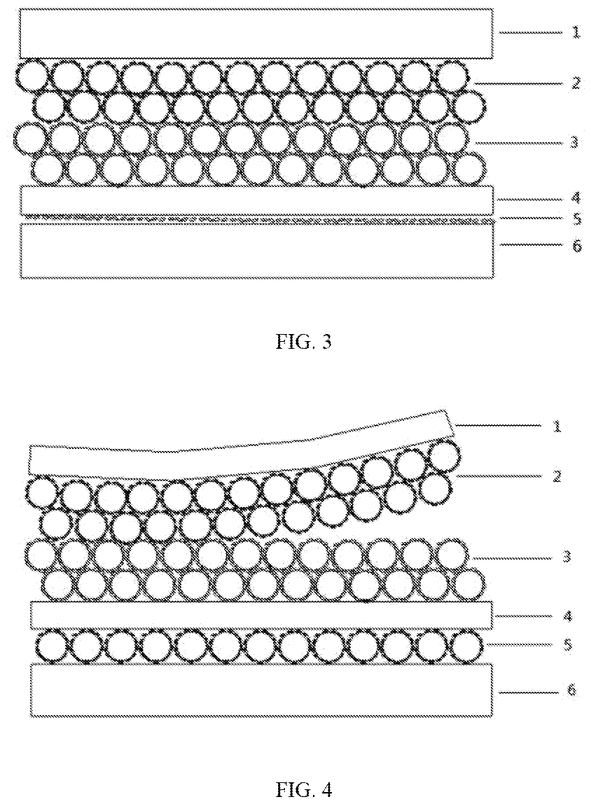

In some embodiments, as shown in FIG. 3, the third layer 2, the second layer 3, the substrate layer 4, and the fifth layer 5 are sequentially stacked between the positive electrode plate 1 and the negative electrode plate 6. The third layer 2 includes a second binder and second inorganic particles, and has a characteristic of high temperature resistance. The second layer 3 includes a first binder and first inorganic particles, and has a characteristic of low adhesion strength under a high temperature. The fifth layer 5 includes a first binder, and has a characteristic of low adhesion strength under a high temperature. After peeling under a high temperature, an interface between the third layer 2 and the second layer 3 is broken, and peeling occurs, as shown in FIG. 6.

In some embodiments, the electrochemical apparatus of this application includes, but is not limited to: all kinds of primary batteries, secondary batteries, fuel cells, solar cells, or capacitors. In some embodiments, the electrochemical apparatus is a lithium secondary battery. In some embodiments, the lithium secondary battery includes, but is not limited to: a lithium metal secondary battery, a lithium-ion secondary battery, a lithium polymer secondary battery or a lithium-ion polymer secondary battery.

The electrochemical apparatus in this application has better safety performance and can meet application requirements.

III. Electronic Apparatus

This application further provides an electronic apparatus, including the electrochemical apparatus in the second aspect of this application.

The electronic device or apparatus in this application is not particularly limited. In some embodiments, the electronic device of this application includes, but is not limited to: a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a memory card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery a lithium-ion capacitor, or the like.

The following further describes this application with reference to the embodiments by using a lithium-ion battery as an example. It should be understood that these embodiments are merely used to describe this application but not to limit the scope of this application.

Test Method

1. Overcharge Test

Lithium-ion batteries were first discharged to 3.0 V at a constant current of 1C. Then, the lithium-ion batteries were charged to 4.8 V and 5 V at a constant current of 3C, and maintained at these constant voltages for 7 h. Criteria for passing this test are that no lithium-ion batteries caught fire or exploded. Ten lithium-ion batteries in each group were tested.

2. High-Temperature Storage Test

Lithium-ion batteries were charged to 4.4 V at a constant current of 1C, and then charged at a constant voltage until a current decreased to 0.05C. The lithium-ion batteries were placed in an 80° C. high temperature box and stored for 24 h, and swelling rates of the lithium-ion batteries were tested. Swelling rate=(Thickness of lithium-ion battery after test-Thickness of lithium-ion battery before test)×100%/(Thickness of lithium-ion battery before test).

3. Test for Adhesion Strength Under High Temperature

(1) Separators containing a coating layer were made into finished lithium-ion batteries.

(2) The finished lithium-ion batteries were fully discharged (discharged to 3.0 V at a direct current of 0.5C), and cut into to-be-stretched samples with a width of 20 mm and a length of 10 cm after disassembling. The samples were placed in a fume hood to air dry for 12 h. After air drying, the samples were bonded to 20 mm wide steel plates by using a double-sided tape, and the to-be-stretched samples were manually pre-stretched by 1 cm, so that peeling occurs at interfaces to form a 180° C. peeling test direction.

(3) The high temperature box was set to a target temperature. The high temperature box reached the target temperature±2° C. and maintained at that temperature for 5 min.

(4) The samples were placed in the high temperature box, and after the temperature reached the target temperature±2° C. and was maintained for 5 min, a tensile test was started on a tensile test machine.

4. Differential Scanning Calorimetry Test

The lithium-ion batteries were disassembled after discharge, and powder of coating layers on surfaces of electrode plates and substrate layers of the separators was collected by scraping. The collected powder was washed with dimethyl carbonate (DMC), dried, and transferred to a crucible. Heat generation power and heat release power of the samples were measured at a temperature rise rate of 1° C./min

### EXAMPLES AND COMPARATIVE EXAMPLES

### Example 1

(1) Preparation of Positive Electrode Plate

A positive electrode active material lithium cobalt oxide (LiCoO₂), a conductive agent Super-P, and a binder polyvinylidene fluoride (PVDF) were mixed in a solvent N-methylpyrrolidone (NMP) at a mass ratio of 97:1.4:1.6, and the system was stirred by using a vacuum mixer to obtain a uniform positive electrode slurry. The positive electrode slurry was applied on a positive electrode current collector aluminum foil, and the aluminum foil was dried at 85° C. Then, after cold pressing, cutting, and slitting, drying was performed in vacuum at 85° C. for 4 h to obtain a positive electrode, or positive electrode plate.

(2) Preparation of Negative Electrode Plate

A negative active material artificial graphite, a thickener sodium carboxymethyl cellulose (CMC), and a binder styrene butadiene rubber (SBR) were mixed at a mass ratio of 97:2:1, and added into deionized water. The mixture was stirred by using a vacuum mixer to obtain a negative electrode slurry. The negative electrode slurry was uniformly applied on a negative electrode current collector copper foil, and the copper foil was dried at 85C. Then, after cold pressing, cutting, and slitting, drying was performed in vacuum at 120° C. for 12 h to obtain a negative electrode, or negative electrode plate.

(3) Preparation of Separator

Referring to FIG. 1, a surface of a substrate layer 4 close to a positive electrode plate 1 was sequentially coated with a second layer 3 and a third layer 2, and a surface of the substrate layer 4 close to a negative electrode plate 6 was coated with a fifth layer 5.

The substrate layer 4 was made of 7 μm thick polyethylene.

Composition of the second layer 3 was as follows: first binder: dispersant: first inorganic particle=5%: 1%: 94% (mass ratio). The first binder was an ethylene propylene polymer, the dispersant was sodium carboxymethyl cellulose, the first inorganic particles were aluminum oxide, and a solvent was deionized water. The coating layer was 1 μm to 2 μm thick.

Composition of the third layer 2 was as follows: second binder: second inorganic particle=4%:96% (mass ratio). The second binder was polyvinylidene fluoride-hexafluoroethylene copolymer (PVDF-HFP), the second inorganic particles were aluminum oxide, and a solvent was N-methylpyrrolidone (NMP). The coating layer was 1 μm to 2 μm thick.

Composition of the fifth layer 5 was as follows: second binder: second inorganic particle=4%: 96% (mass ratio). The second binder was polyvinylidene fluoride-hexafluoroethylene copolymer (PVDF-HFP), the second inorganic particles were aluminum oxide, and a solvent was pyrrolidone. The coating layer was 1 μm to 2 μm thick.

(4) Electrolyte

In a dry argon atmosphere glove box, ethylene carbonate (EC) propylene carbonate (PC), and diethyl carbonate (DEC) were mixed at a mass ratio of 3:4:3 to obtain a uniform mixture. Then, 4% of fluoroethylene carbonate (FEC) was added and dissolved, and the mixture was fully stirred. Then a lithium salt LiPF₆ was added and well mixed to obtain an electrolyte, with a concentration of LiPF₆ being 1.05 mol/L.

(5) Method for Preparing Finished Lithium-Ion Battery

The positive electrode, the separator, and the negative electrode were stacked in order, so that the separator was placed between the positive electrode and the negative electrode for separation. Then the stack was wound and welded with tabs, and then placed in an outer packaging aluminum foil film. Then the foregoing prepared electrolyte was injected, followed by processes such as vacuum packaging, standing, formation, shaping and capacity testing, to obtain a lithium-ion battery.

The separator in Example 1 was subjected to tests on adhesion strength under high temperature. The results are shown in FIG. 8. F1′ was an interfacial adhesion strength between the third layer 2 and the positive electrode plate, F2′ was an interfacial adhesion strength between the second layer 3 and the third layer 2, and F1′ and F2′ made the following relations hold:

(1) In the case of T<100° C., F1′ barely changed and basically stayed at 15 N/m, and F2′ barely changed and was basically around 15 N/m;

(2) In the case of 100° C.≤T, F2′=−0.47 T+62:

(3) In the case of T≤130° C. F1′=15 N/m; and

(4) In the case of T>13° C., F1′=−0.09 T+27.

It can be learned that when the temperature was >100° C., F2′ started to decrease significantly, and F1′ decreased slowly from 130° C.

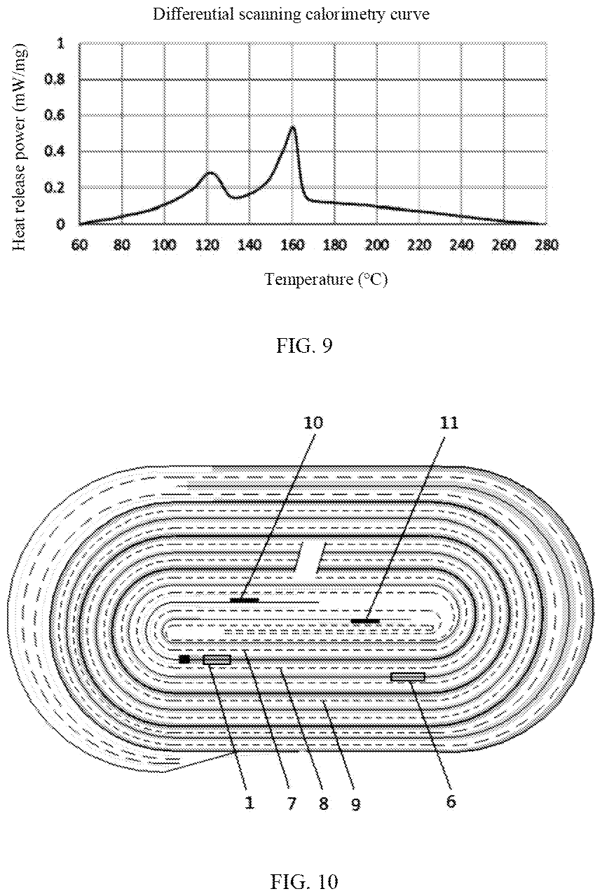

A coating layer of the separator in Example 1 was subjected to differential scanning calorimetry tests. The results are shown in FIG. 9. It can be learned that in a differential scanning calorimetry curve, there were two endothermic peaks: a temperature corresponding to a first endothermic peak was 120° C. and a temperature corresponding to a second endothermic peak was 160° C.

A lithium-ion battery prepared in Example 1 was disassembled, and it was found that after the battery was overcharged, inorganic particles were obviously transferred to a surface of the positive electrode plate.

### Examples 2 to 7

The methods were the same as the method for preparing the lithium-ion battery in Example 1 except that types of the first binder and the second binder in the separator were adjusted. Details are given in Table 1.

### Comparative Example 1

The method was the same as the method for preparing the lithium-ion battery in Example 1 except that a coating layer was applied only on a surface of a substrate layer of a separator close to a positive electrode plate 1. Composition of the coating layer was as follows:

A second binder was polyvinylidene fluoride, second inorganic particles were aluminum oxide, second binder:second inorganic particle was equal to 4%:96% (mass ratio), and a solvent was pyrrolidone. The coating layer was 3 μm thick.

A lithium-ion battery prepared in Comparative Example 1 was disassembled, and it was found that after the battery was overcharged, no inorganic particles were obviously transferred to a surface of the positive electrode plate.

### Comparative Example 2

The methods were the same as the method for preparing the lithium-ion battery in Example 1 except that types of the first binder and the second binder in the separator were adjusted. Details are given in Table 1.

### Comparative Example 3

The method was the same as the method for preparing the lithium-ion battery in Example 1 except that a coating layer was applied only on a surface of a substrate layer of a separator close to a positive electrode plate 1. Composition of the coating layer was as follows:

A first binder was ethylene-vinyl acetate resin, first inorganic particles were aluminum oxide, first binder:first inorganic particle was equal to 4%:96% (mass ratio), and a solvent was pyrrolidone. The coating layer was 3 μm thick.

### Test Result

See Table 1 for test results.

TABLE 1

| | | | First | First | | | | |
|---|---|---|---|---|---|---|---|---|
| | | | absorption | absorption | | | | |
| | | | peak of | peak of | | | | |
| | | | differential | differential | | Swelling | | |
| | | | scanning | scaning | | rate for | Pass rate for | Pass rate for |
| | | | calorimetry | calorimetry | | storage | overcharge | overcharge |
| | | | curve at Q₁ | curve at Q₂ | Q₂-Q₁ | at 80° C. | at 3 C | at 3 C |
| | First binder | Second binder | (° C.) | (° C.) | (° C.) | for 24 h | and 4.8 V | and 5 V |
| Comparative | / | Polyvinylidene fluoride | / | 168 | / | 8% | 2/10 | 0/10 |
| Example 1 | | | | | | | | |
| Comparative | Polyvinylidene | Polyvinylidene fluoride | 160 | 168 | 8 | 8% | 3/10 | 0/10 |
| Example 2 | fluoride- | | | | | | | |
| | hexafluoroethylene | | | | | | | |
| | copolymer | | | | | | | |
| Comparative | Ethylene-vinyl | / | 80 | / | / | 20% | 10/10 | 3/10 |
| Example 3 | acetate resin | | | | | | | |
| Example 1 | Ethylene-propylene | Polyvinylidene fluoride- | 120 | 160 | 40 | 8% | 10/10 | 10/10 |
| | random polymer | hexafluoroethylene | | | | | | |
| | | copolymer | | | | | | |
| Example 2 | Ethylene-propylene | Ethylene-propylene | 120 | 135 | 15 | 8% | 10/10 | 5/10 |
| | random polymer | copolymer | | | | | | |
| Example 3 | Block copolymer | Polyvinylidene floride- | 122 | 160 | 38 | 8% | 10/10 | 10/10 |
| | polypropylene | hexsfluorethylene | | | | | | |
| | | copolymer | | | | | | |
| Example 4 | Ethylene-propylene | Polypropylene | 120 | 189 | 69 | 8% | 10/10 | 5/10 |
| | random polymer | | | | | | | |
| Example 5 | Ethylene-propylene | Ethylene-butene | 120 | 140 | 20 | 8% | 10/10 | 10/10 |
| | random polymer | copolymer | | | | | | |
| Example 6 | Ethylene-propylene | Ethylene-propylene- | 120 | 137 | 17 | 8% | 10/10 | 6/10 |
| | random polymer | butene copolymer | | | | | | |
| Example 7 | Ethylene-propylene | Polyvinylidene fluoride | 120 | 167 | 47 | 8% | 10/10 | 10/10 |
| | random polymer | | | | | | | |

In Comparative Example 1 and Comparative Example 2, only a third layer was high-temperature resistant, and an interface between a separator and an electrode plate could hardly be broken. Therefore, a heat dissipation effect was undesirable, and an overcharge pass rate was low. In Comparative Example 3, only a second layer had a low adhesion strength under a high temperature, separation was uneven, and a surface of an electrode plate was not protected by inorganic particles. As a result, although an overcharge pass rate at 3C and 4.8 V was slightly increased, an overcharge pass rate at 3C and 5 V was still low, and separation after 80° C. storage test caused a swelling rate of an electrochemical apparatus to increase sharply. In Example 2 and Example 6, a second layer with a low adhesion strength under a high temperature was combined with a third layer with high temperature resistance. A difference between melting points of the third layer and the second layer was less than 20° C., and interfaces of these two layers were separated at the same time. As a result, an overcharge pass rate was increased, but an overcharge pass rate at 3C and 5 V remained to be further increased. In Example 4, a second layer with a low adhesion strength under a high temperature was combined with a third layer with high temperature resistance. A difference between melting points of the third layer and the second layer was greater than 60° C., separation was not desirable, and an adhesion strength between the third layer and an electrode plate was low. As a result, an overcharge pass rate was increased, but an overcharge pass rate at 3C and 5 V remained to be further increased. Example 1, Example 3, Example 4, Example 5, and Example 7 were preferred combinations. While a second layer with a low adhesion strength under a high temperature was peeled off for better dissipation, the third layer with high temperature resistance was firmly bonded to the surface of the electrode plate, and a coating layer was transferred to the surface of the electrode plate to prevent short circuit. As a result, an overcharge pass rate at 3C and 5 V was high, without a significant increase in swelling rate after 80° C. storage test.

Although illustrative embodiments have been demonstrated and described, a person skilled in the art should understand that the foregoing embodiments are not to be construed as limiting this application, and that the embodiments may be changed, replaced, and modified without departing from the spirit, principle, and scope of this application.

1. A separator, comprising a substrate layer and a first layer disposed on a surface of the substrate layer, wherein a differential scanning calorimetry curve of the first layer has a first endothermic peak and a second endothermic peak, wherein a temperature corresponding to the first endothermic peak is Q₁° C., a temperature corresponding to the second endothermic peak is Q₂° C., 100≤Q₁130, and 140≤Q₂≤200.

2. The separator according to claim 1, wherein F₂₅ represents an adhesion strength between the first layer and the substrate layer measured at 25° C., EQ₁₋₁₀ represents an adhesion strength between the first layer and the substrate layer measured at Q₁₋₁₀° C., and −0.05 N/m≤F_{Q1-10}−F₂₅≤0.05 N/m; and Fₜ₁ represents an adhesion strength between the first layer and the substrate layer measured at t₁° C., Fₜ₂ represents an adhesion strength between the first layer and the substrate layer measured at t₂° C., t₁>t₂>Q₁−10, and Fₜ₁<Fₜ₂; and/or
F represents an adhesion strength between the first layer and the substrate layer measured at a temperature t° C., 0 N/m<F≤2 N/m, and Q₁−10≤t≤Q₂.

3. The separator according to claim 1, wherein 20≤Q₂−Q₁≤60.

4. The separator according to claim 1, wherein the first layer comprises a second layer and a third layer, and the second layer is stacked with the third layer and located between the substrate layer and the third layer; wherein the second layer comprises first inorganic particles and a first binder, and the third layer comprises second inorganic particles and a second binder.

5. The separator according to claim 1, wherein the first layer comprises a first adhesive layer, a fourth layer, and a second adhesive layer stacked in sequence, and the first adhesive layer is located between the substrate layer and the fourth layer; wherein the first adhesive layer comprises a first binder, the second adhesive layer comprises a second binder, and the fourth layer comprises second inorganic particles.

6. The separator according to claim 4, wherein
the first inorganic particles are selected from one or more of aluminum oxide, magnesium oxide, silicon dioxide, titanium dioxide, zirconium dioxide, aluminum hydroxide, magnesium hydroxide, zine oxide, barium sulfate, or boehmite;
the second inorganic particles are selected from one or more of aluminum oxide, magnesium oxide, silicon dioxide, titanium dioxide, zirconium dioxide, aluminum hydroxide, magnesium hydroxide, zinc oxide, barium sulfate, or boehmite;
the first binder comprises one or more of ethylene-propylene random polymer, ethylene propylene rubber, or block copolymer polypropylene; and
the second binder comprises one or more of polypropylene, ethylene-butene copolymer, ethylene-propylene copolymer, propylene-butene copolymer, or ethylene-propylene-butene copolymer.

7. The separator according to claim 5, wherein
the second inorganic particles are selected from one or more of aluminum oxide, magnesium oxide, silicon dioxide, titanium dioxide, zirconium dioxide, aluminum hydroxide, magnesium hydroxide, zinc oxide, barium sulfate, or boehmite;
time first binder comprises one or more of ethylene-propylene random polymer, ethylene propylene rubber, or block copolymer polypropylene; and
the second binder comprises one or more of polypropylene, ethylene-butene copolymer, ethylene-propylene copolymer, propylene-butene copolymer, or ethylene-propylene-butene copolymer.

8. An electrochemical apparatus, comprising an electrode assembly, wherein the electrode assembly comprises a first electrode plate, a second electrode plate, and a separator;
wherein the separator comprises a substrate layer and a first layer disposed on a surface of the substrate layer, wherein a differential scanning calorimetry curve of the first layer has a first endothermic peak and a second endothermic peak, wherein a temperature corresponding to the first endothermic peak is Q₁° C., a temperature corresponding to the second endothermic peak is Q₂° C., 100≤Q₁≤130, and 140≤Q₂ 200;
wherein the separator is stacked between the first electrode plate and the second electrode plate, and the first layer is in contact with the first electrode plate.

9. The electrochemical apparatus according to claim 8, wherein the first layer comprises second inorganic particles, the first electrode plate comprises a first current collector and a first active material layer that are stacked, the first electrode plate has a first portion, and a surface of the first active material layer of the first portion is covered with the second inorganic particles; and
S₁ represents an area, measured at t₃° C., of the surface of the first active material layer of the first portion covered by the second inorganic particles, S₂ represents an area, measured at t₄° C., of the surface of the first active material layer of the first portion covered by the second inorganic particles, S₂>S₁, t₃≤30, and Q₁≤t₄≤Q₂.

10. The electrochemical apparatus according to claim 8, wherein the separator further comprises a fifth layer disposed on a surface of the substrate layer, the first layer and the fifth layer are respectively provided on two opposite surfaces of the substrate layer, the fifth layer is in contact with the second electrode plate, and the fifth layer comprises the first binder and/or the second binder.

11. The electrochemical apparatus according to claim 8, wherein F₂₅ represents an adhesion strength between the first layer and the substrate layer measured at 25° C., F_{Q1-10} represents an adhesion strength between the first layer and the substrate layer measured at Q₁−10° C., and −0.05 N/m≤F_{Q1-10}−F₂₅≤0.05 N/m; and Fₜ₁ represents an adhesion strength between the first layer and the substrate layer measured at t₁° C., Fₜ₂ represents an adhesion strength between the first layer and the substrate layer measured at t₂° C., t₁>t₂>Q₁−10, and Fₜ₁<Fₜ₂; and/or
F represents an adhesion strength between the first layer and the substrate layer measured at a temperature t° C., 0 N/m<F≤2 N/m, and Q₁-10≤t≤Q₂.

12. The electrochemical apparatus according to claim 8, The separator according to claim 1, wherein 20≤Q₂−Q₁≤60.

13. The electrochemical apparatus according to claim 8, wherein the first layer comprises a second layer and a third layer, and the second layer is stacked with the third layer and located between the substrate layer and the third layer; wherein the second layer comprises first inorganic particles and a first binder, and the third layer comprises second inorganic particles and a second binder.

14. The electrochemical apparatus according to claim 8, wherein the first layer comprises a first adhesive layer, a fourth layer, and a second adhesive layer stacked in sequence, and the first adhesive layer is located between the substrate layer and the fourth layer; wherein the first adhesive layer comprises a first binder, the second adhesive layer comprises a second binder, and the fourth layer comprises second inorganic particles.

15. The electrochemical apparatus according to claim 13, wherein
the first inorganic particles are selected from one or more of aluminum oxide, magnesium oxide, silicon dioxide, titanium dioxide, zirconium dioxide, aluminum hydroxide, magnesium hydroxide, zinc oxide, barium sulfate, or boehmite;
the second inorganic particles are selected from one or more of aluminum oxide, magnesium oxide, silicon dioxide, titanium dioxide, zirconium dioxide, aluminum hydroxide, magnesium hydroxide, zinc oxide, barium sulfate, or boehmite;
the first binder comprises one or more of ethylene-propylene random polymer, ethylene propylene rubber, or block copolymer polypropylene; and
the second binder comprises one or more of polypropylene, ethylene-butene copolymer, ethylene-propylene copolymer, propylene-butene copolymer, or ethylene-propylene-butene copolymer.

16. The electrochemical apparatus according to claim 14, wherein
the second inorganic particles are selected from one or more of aluminum oxide, magnesium oxide, silicon dioxide, titanium dioxide, zirconium dioxide, aluminum hydroxide, magnesium hydroxide, zinc oxide, barium sulfite, or boehmite;
the first binder comprises one or more of ethylene-propylene random polymer, ethylene propylene rubber, or block copolymer polypropylene; and
the second binder comprises one or more of polypropylene, ethylene-butene copolymer, ethylene-propylene copolymer, propylene-butene copolymer, or ethylene-propylene-butene copolymer.

17. An electronic apparatus, comprising an electrochemical apparatus, wherein the electrochemical apparatus comprises an electrode assembly, wherein the electrode assembly comprises a first electrode plate, a second electrode plate, and a separator,
wherein the separator comprises a substrate layer and a first layer disposed on a surface of the substrate layer, wherein a differential scanning calorimetry curve of the first layer has a first endothermic peak and a second endothermic peak, wherein a temperature corresponding to the first endothermic peak is Q₁° C., a temperature corresponding to the second endothermic peak is Q₂° C., 100≤Q₁≤130, and 140≤Q₂≤200;
wherein the separator is stacked between the first electrode plate and the second electrode plate, and the first layer is in contact with the first electrode plate.

18. The electronic apparatus according to claim 17, wherein the first layer comprises second inorganic particles, the first electrode plate comprises a first current collector and a first active material layer that are stacked, the first electrode plate has a first portion, and a surface of the first active material layer of the first portion is covered with the second inorganic particles; and
S₁ represents an area, measured at t₃° C., of the surface of the first active material layer of the first portion covered by the second inorganic particles, S₂ represents an area, measured at t₄° C., of the surface of the first active material layer of the first portion covered by the second inorganic particles, S₂>S₁, t₃≤30, and Q₁≤t₄≤Q₂.

19. The electronic apparatus according to claim 17, wherein the separator further comprises a fifth layer disposed on a surface of the substrate layer, the first layer and the fifth layer are respectively provided on two opposite surfaces of the substrate layer, the fifth layer is in contact with the second electrode plate, and the fifth layer comprises the first binder and/or the second binder.

20. The electronic apparatus according to claim 18, wherein the second inorganic particles are selected from one or more of aluminum oxide, magnesium oxide, silicon dioxide, titanium dioxide, zirconium dioxide, aluminum hydroxide, magnesium hydroxide, zinc oxide, barium sulfate, or boehmite.
